(19) United States
(12) Patent Application Publication
(10) Pub. No.: US 2024/0186731 A1
(43) Pub. Date: Jun. 6, 2024

(54) ELECTRICAL ASSEMBLY

(71) Applicant: Lear Corporation, Southfield, MI (US)

(72) Inventor: Albert M. Cabañero, Cebu City (PH)

(21) Appl. No.: 18/074,850

(22) Filed: Dec. 5, 2022

(51) Int. Cl. H01R 12/59; H01R 43/027

(52) U.S. Cl. CPC H01R 12/59; H01R 43/027

(57) ABSTRACT

An assembly includes a first cover, a second cover, a first male insert, a first female insert, a second male insert, a second female insert, and/or a busbar, in some configurations. The second cover may be connected with the first cover. The first male insert may be connected to the first cover. The first female insert may be connected to the second cover and the first male insert. The second male insert may be connected to one of the first cover and the second cover. The second female insert may be connected to the second male insert and the other one of the first cover and the second cover. The busbar may be in contact with the first female insert and the second female insert.

### TECHNICAL FIELD

The present disclosure generally relates to electrical assemblies, including flat cables and/or busbars that may, for example, be utilized in connection with and/or incorporated in vehicles.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is an exploded perspective view generally illustrating an embodiment of an electrical assembly according to teachings of the present disclosure.

FIG. 2 is a perspective view generally illustrating an embodiment of an electrical assembly according to teachings of the present disclosure.

FIGS. 3 and 4 are perspective views generally illustrating portions of an embodiment of a cover according to teachings of the present disclosure.

FIG. 5 is a front view generally illustrating an embodiment of a cover according to teachings of the present disclosure.

FIG. 6 is a perspective view generally illustrating an embodiment of a male insert according to teachings of the present disclosure.

FIG. 7 is a perspective view generally illustrating an embodiment of a female insert according to teachings of the present disclosure.

FIG. 8 is a top view generally illustrating an embodiment of a busbar according to teachings of the present disclosure.

FIG. 9 is a top view generally illustrating portions of an embodiment of a flat cable according to teachings of the present disclosure.

FIG. 10 is a perspective view generally illustrating an embodiment of a spring clip according to teachings of the present disclosure.

FIGS. 11, 12A, and 13 are perspective views generally illustrating portions of an embodiment of a method of assembling an electrical assembly according to teachings of the present disclosure.

FIG. 12B is a cross-sectional view generally illustrating portions of an embodiment of an insert, a cover, and an insertion tool according to teachings of the present disclosure.

FIG. 14A is a cross-sectional view generally illustrating an embodiment of a male insert and a cover according to teachings of the present disclosure.

FIG. 14B is a cross-sectional view generally illustrating an embodiment of a female insert and a cover according to teachings of the present disclosure.

FIGS. 15-17 are top views generally illustrating embodiment electrical assemblies with different insert configurations according to teachings of the present disclosure.

FIGS. 18-20 are perspective views generally illustrating portions of an embodiment of a method of assembling an electrical assembly according to teachings of the present disclosure.

FIG. 21 is a cross-sectional view generally illustrating an embodiment of portions of an electrical assembly, with covers hidden, according to teachings of the present disclosure.

FIGS. 22 and 23 are perspective views generally illustrating portions of an embodiment of a method of assembling an electrical assembly according to teachings of the present disclosure.

FIG. 24 is a cross-sectional view generally illustrating an embodiment of an electrical assembly according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

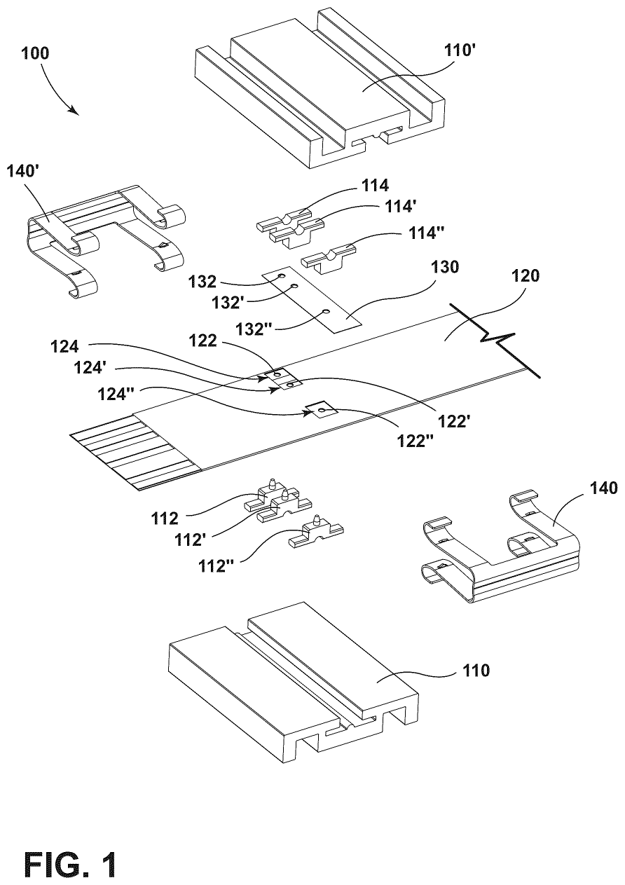

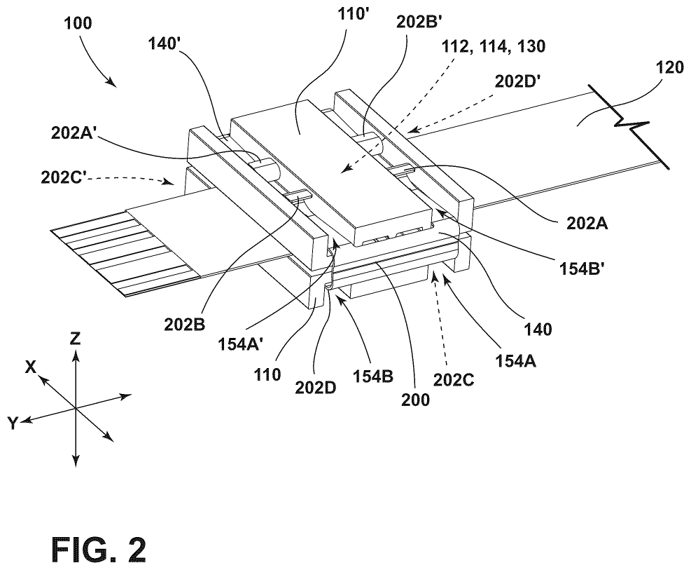

FIGS. 1 and 2 present an electrical assembly 100 including a first cover 110, a second cover 110′, a plurality of male inserts 112 (e.g., male inserts 112, 112′, 112″), a plurality of female inserts 114 (e.g., female inserts 114, 114′, 114″), a flat cable 120, a busbar 130, a first spring clip 140, and/or a second spring clip 140′. The first cover 110 is configured for connection with the second cover 110′, the male inserts 112, the female inserts 114, the flat cable 120, the first spring clip 140, and/or the second spring clip 140′. The second cover 110′ is configured for connection with the first cover 110, the male inserts 112, the female inserts 114, the flat cable 120, the first spring clip 140, and/or the second spring clip 140′. The male inserts 112 are configured for connection with the first cover 110, the second cover 110′, the female inserts 114, the flat cable 120, and/or the busbar 130. The female inserts 114 are configured for connection with the first cover 110, the second cover 110′, the male inserts 112, and/or the busbar 130. The busbar 130 is configured for connection with the male inserts 112, the female inserts 114, and/or the flat cable 120. The first spring clip 140 and the second spring clip 140′ are configured for connection with the first cover 110 and the second cover 110′.

In some configurations, the flat cable 120 includes a plurality of conductors 122 (e.g., conductors 122, 122′, 122″). In an assembled configuration, a first male insert 112 may be connected to the first cover 110′. A first female insert 114 may be connected to the second cover 110′ and the first male insert 112. A second male insert 112′ may be connected to one of the first cover 110 and the second cover 110′. A second female insert 114′ may be connected to the second male insert 112′ and the other one of the first cover 110 and the second cover 110′. A portion of the flat cable 120 is disposed between the first cover 110 and the second cover 110′. The busbar 130 is in contact with the first female insert 114 and the second female insert 114′. The second cover 110′ is connected with the first cover 110 such that a first conductor 122 of the cable 120 is electrically connected with a second conductor 122′ via the busbar 130 (e.g., the electrical assembly 100 may be configured as a splice connector). The first male insert 112, the second male insert 112′, the first female insert 114, and the second female insert 114′ may facilitate alignment, connection, and/or retention of the busbar 130, the first conductor 122, and/or the second conductor 122′, such as to facilitate an electrical connection therebetween.

Referring now to FIGS. 1, 8 and 9, in some examples, the first conductor 122 includes a first cable hole 124, the second conductor 122′ includes a second cable hole 124″, and/or the busbar 130 includes a first busbar hole 132 and a second busbar hole 132′. In an assembled configuration, the first male insert 112 is partially disposed within the first cable hole 124 and the first busbar hole 132, and/or the second male insert 112′ is partially disposed within the second cable hole 124′ and the second busbar hole 132′. The electrical assembly 100 is shown including three male inserts 112, three female inserts 114, three conductors 122, three cable holes 124, and three busbar holes 132. However, the electrical assembly 100 may include more or less than three male inserts 112, more or less than three female inserts 114, more or less than three conductors 122, more or less than three cable holes 124, and/or more or less than three busbar holes 132.

In some embodiments, the second cover 110′ includes an identical configuration as the first cover 110. For example and without limitation, a cover 110 may be reversible such that the cover 110 is configured to mate with a second cover 110′ having the same configuration to electrically connect a conductor 122 of the flat cable 120 with a second conductor 122′ of the flat cable 120. In some configurations, the second cover 110′ may be rotated 180 degrees about a Y-axis or an X-axis relative to the first cover 110, and then mated with the first cover 110 (see, e.g., FIG. 2).

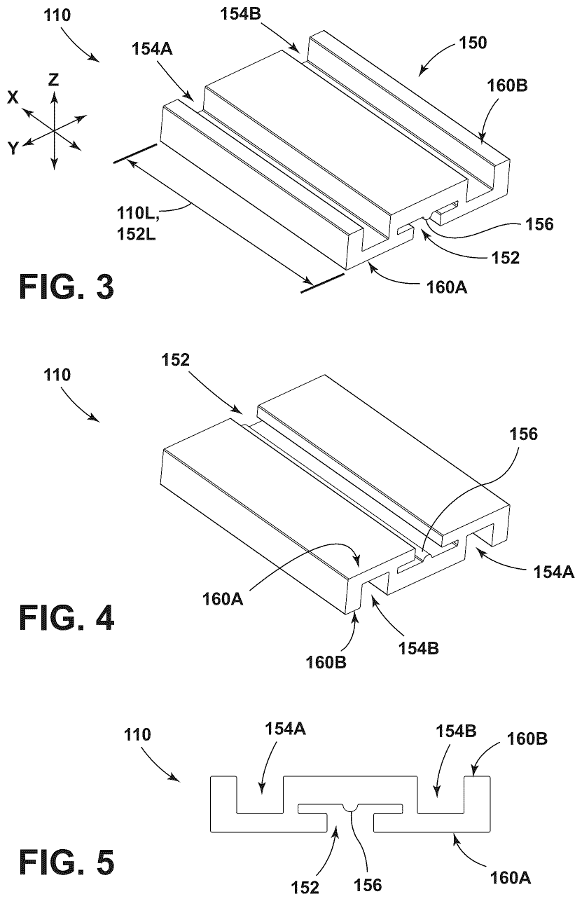

FIGS. 3-5 illustrate a cover 110 including an elongated body 150, an inner channel 152, one or more outer channels 154 (e.g., a first outer channel 154A and/or a second outer channel 154B), and/or a rib 156. The inner channel 152 may include a T-shaped configuration. The inner channel 152 may be accessible via a first side 160A of the cover 110. The inner channel 152 may extend along some of or an entire length 110L of the cover 110 (e.g., along an X-axis). The rib 156 is disposed in the inner channel 152. The rib 156 may extend along some of or an entire length 152L of the inner channel 152. The outer channel 154A and the second outer channel 154B may be accessible via a second side 160B of the cover 110, the second side 160B is opposite the first side 160A. The outer channel 154A and the second outer channel 154B may be disposed on opposing sides of the inner channel 152 and/or may extend parallel to the inner channel 152. The outer channel 154A and the second outer channel 154B may extend along some of or the entire length 110L of the cover 110. In some implementations, the cover 110 may be produced via an extrusion process and/or may comprise a material that is not electrically conductive.

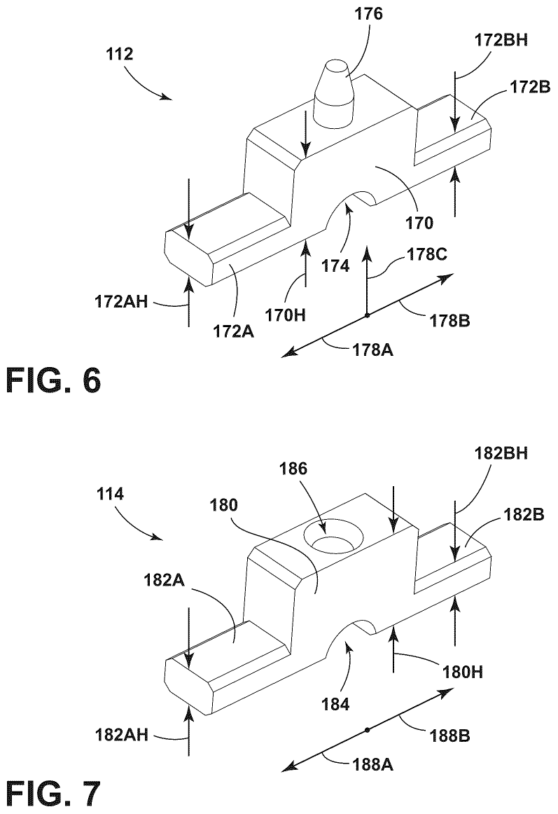

FIG. 6 illustrates a male insert 112 including a base 170, a first portion 172A, a second portion 172B, a recess 174, and/or a protrusion 176. In some examples, the male insert 112 may include a T-shaped configuration. The first portion 172A may extend from the base 170 in a first direction 178A and/or the second portion 172B may extend from the base 170 in a second direction 178B opposite the first direction 178A. In an assembled configuration, directions 178A, 178B may be parallel to a Y-direction. In some configurations, the base 170 includes a height 170H that is greater than a height 172AH of the first portion 172A and a height 172BH of the second portion 172B. The recess 174 may be disposed within the base 170 and/or may include a shape corresponding to a shape of the rib 156 of a cover 110. The protrusion 176 may extend from the base 170 in a third direction 178C (e.g., a Z-direction) perpendicular to the first direction 178A and the second direction 178B. The protrusion 176 may be configured for connection with (e.g., insertion into) the flat cable 120, the busbar 130, and/or a female insert 114. The male insert 112 may comprise a material that is not electrically conductive.

FIG. 7 illustrates a female insert 114 including a base 180, a first portion 182A, a second portion 182B, a recess 184, and/or a void 186. In some examples, the female insert 114 may include a T-shaped configuration. The first portion 182A may extend from the base 180 in a first direction 188A and/or the second portion 182B may extend from the base 180 in a second direction 188B opposite the first direction 188A. In an assembled configuration, directions 188A, 188B may be parallel to a Y-direction. In some configurations, the base 180 includes a height 180H that is greater than a height 182AH of the first portion 182A and a height 182BH of the second portion 182B. The recess 184 may be disposed within the base 180 and/or may include a shape corresponding to a shape of the rib 156 of a cover 110. The void 186 is disposed within the base 180. The void 186 may include a shape corresponding to a shape of a protrusion 176 of a male insert 112 and may be configured to receive some, most, or all of the protrusion 176. The female insert 114 may a material that is not electrically conductive.

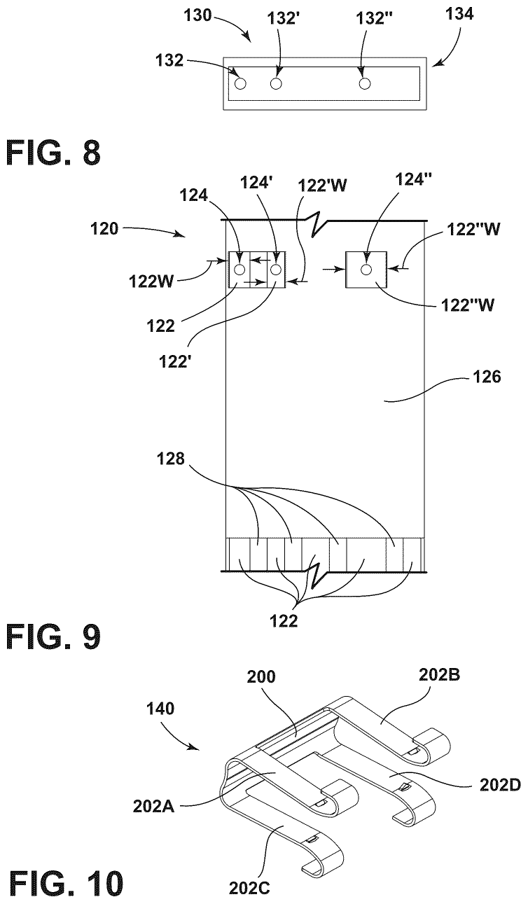

FIG. 8 illustrates a busbar 130 with busbar holes 132 (e.g., holes 132, 132′, 132″). The busbar 130 may include a hole 132 for each conductor 122 that is to be connected. Each hole 132 may be configured to receive a protrusion 176 to facilitate alignment and retention of the busbar 130. An insulator 134 may be connected to one side of the busbar 130. The other side of the busbar may contact exposed portions of the conductors 122.

With reference to FIG. 9, a flat cable 120 includes an elongated body 126 having a plurality of electrical conductors 122 and/or an insulating material 128 that may electrically insulate the conductors 122 from each other and/or other components. The conductors 122 may be disposed in parallel with each other and/or may be substantially aligned with a common plane. The conductors 122 may, in some configurations, be integrally formed with the insulating material 128. At least some of the conductors 122 are selectively exposed (e.g., conductors 122, 122′, 122″). The conductors 122 may have varying sized widths. For example and without limitation, a first conductor 122 includes a first width 122W, a second conductor 122′ includes a second width 122′W, and/or a third conductor 122″ includes a third width 122″W. The first width 122W may be different from the second width 122′W and/or the third width 122″W. In some instances, the first width 122W may be the same as the second width 122′W and/or the third width 122″W.

FIG. 10 illustrates a spring clip 140 including a base 200 and a plurality of legs 202 (e.g., legs 202A, 202B, 202C, 202D). The legs 202 extend from the base 200 in a U-shaped or C-shaped configuration, in some embodiments. In an assembled configuration, the legs 202 are disposed in outer channels 154 of the covers 110, 110′ (see, e.g., FIG. 2). A spring clip 140 is configured to secure a first cover 110 with a second cover 110′. The spring clip 140 is shown having four legs 202, however the spring clip 140 may include more or less than four legs 202.

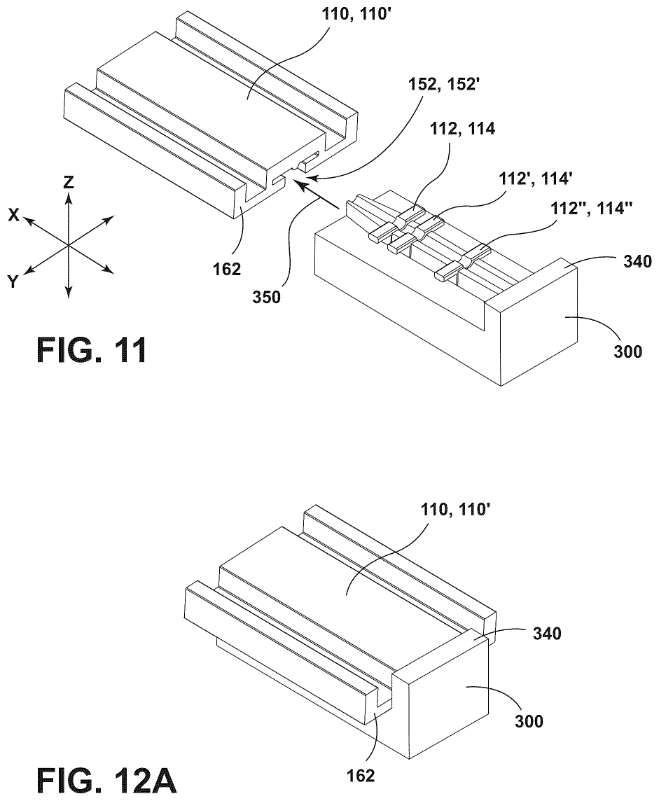

FIGS. 11-24 present a method of assembling an electrical assembly 100. Referring now to FIGS. 11-14, the method includes inserting at least two inserts 112, 114 into an inner channel 152 of a first cover 110 such that the inserts 112, 114 are connected to the first cover 110. The number of inserts 112, 114 are chosen to correspond to the number of electrical conductors 122 of the cable 120 that are desired to be electrically connected via the electrical assembly 100. The inserts may be all male inserts 112, all female inserts 114, or a combination thereof. For example, in some implementations, a first male insert 112, a second male insert 112′, and/or a third male insert 112″ may be inserted into the inner channel 152 of the first cover 110. The inserts 112, 114 are inserted into the inner channel 152 via an insertion tool 300.

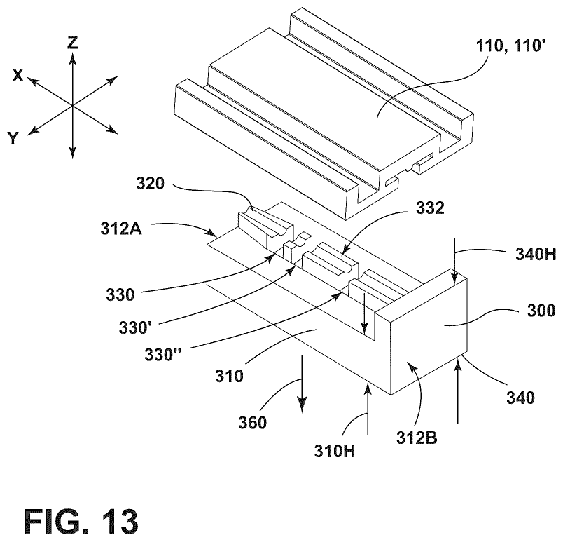

With reference to FIG. 13, in some configurations, an insertion tool 300 (e.g., a jig) includes a base 310 having an internal structure 320 comprising a plurality of channels 330 (e.g., channels 330, 330′, 330″) and/or an end wall 340. A channel 330 receives a male insert 112 and/or a female insert 114. The channels 330 are positioned in the internal structure 320 to correspond to the positioning of the electrical conductors 122 desired to be electrically connected. The base 310 includes a first end 312A and a second end 312B spaced apart from the first end 312A. The end wall 340 is disposed proximate the second end 312B and/or the end wall 340 includes a height 340H greater than a height 310H of the base 310. Once inserted into the insertion tool 300, bases 170, 180 of the inserts 112, 114 are disposed in the channels 330 such that portions 172A, 172B, 182A, 182B are spaced from the base 310, allowing portions of the cover to be inserted between the 172A, 172B, 182A, 182B and the base 310 as the inserts 112, 114 are inserted into the inner channel 152.

In some configurations, the insertion tool 300 includes an upper channel 332 that at least partially engages and/or receives the rib 156 of the cover 110 during insertion. The inserts 112, 114 may be disposed in the insertion tool 300 such that recesses 174, 184 are substantially aligned with the upper channel 332. The shape of the upper channel 332 may correspond to the shape of the rib 156. The channels 330 may intersect with the upper channel 332.

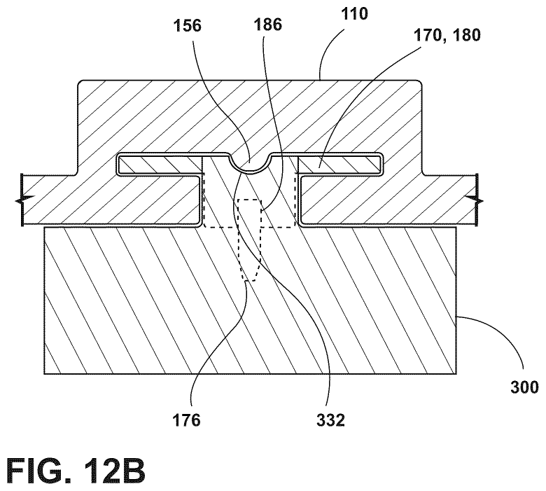

Referring again to FIGS. 11, 12A, and 12B, the method includes disposing each of the inserts 112, 114 into a respective channel 330 of the insertion tool 300 and/or moving the insertion tool 300 in a direction 350 (e.g., parallel to the X-axis) such that at least portions of the inserts 112, 114 are disposed within the inner channel 152 of the first cover 110, and/or such that the end wall 340 of the insertion tool 300 is in contact with an end 162 of the first cover 110.

With reference to FIG. 13, the method includes moving the insertion tool 300 in a direction 360 perpendicular to the direction 350 (e.g., parallel to the Z-axis) such that the insertion tool 300 is separated from the inserts 112, 114 and the first cover 110 and/or the inserts 112, 114 are connected to the first cover 110. The insertion tool 300 may not positively engage the cover 110, so the insertion tool 300 may not be restricted from removal in the Z-direction after insertion in the X-direction. The inserts 112, 114 may include chamfered edges, which may facilitate insertion into the inner channel 152. In some configurations, the inserts 112, 114 may be press fit, at least to some degree (e.g., in one or more dimensions), into the inner channel 152 via the insertion tool 300.

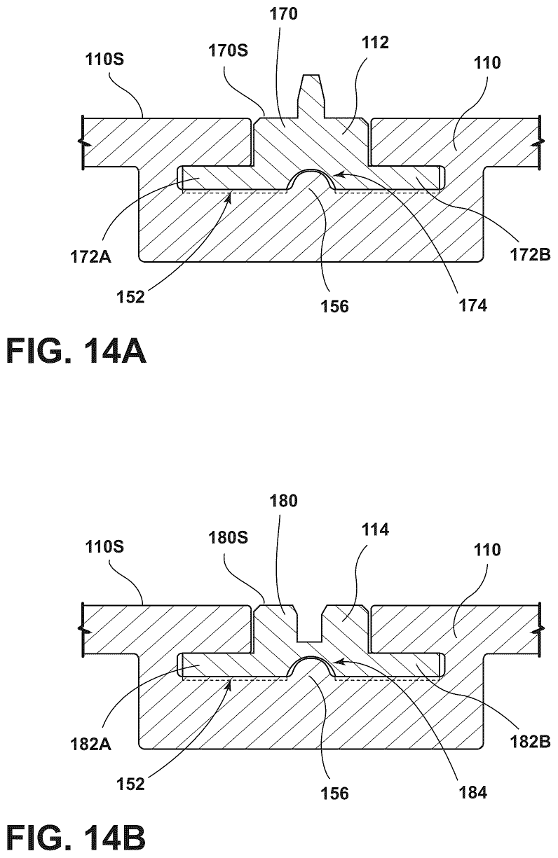

Referring now to FIG. 14A, in an assembled configuration, a first portion 172A, a second portion 172B, and/or a base 170 of a male insert 112 is disposed in the inner channel 152 of the first cover 110. A rib 156 of the cover 110 is disposed in a recess 174 of the male insert 112. An outer surface 170S of the base 170 is aligned flush with an outer surface 110S of the first cover 110.

Referring to FIG. 14B, in an assembled configuration, a first portion 182A, a second portion 182B, and/or a base 180 of a female insert 114 is disposed in the inner channel 152 of a cover 110, which may be the same cover that the male insert 112 is inserted into (e.g., the first cover 110), or may be different cover (e.g., a second cover 110′). A rib 156 of the cover 110 is disposed in a recess 184 of the female insert 114. An outer surface 180S of the base 180 is aligned flush with an outer surface 110S of the cover 110.

The method includes inserting at least two additional inserts 112, 114 into an inner channel 152′ of a second cover 110′ such that the additional inserts 112, 114 are connected to the second cover 110′. The number of additional inserts 112, 114 corresponds to the number of inserts 112, 114 inserted into the first cover 110. For instance, a first female insert 114, a second female insert 114′, and/or a third female insert 114″ may be inserted into the inner channel 152′ of the second cover 110′ if male inserts 112, 112′, 112″ were inserted into inner channel 152. The additional inserts 112, 114 are inserted into the inner channel 152′ and/or connected to the second cover 110′ in a similar manner as the inserts 112, 114 are connected to the first cover 110, for example, via the insertion tool 300.

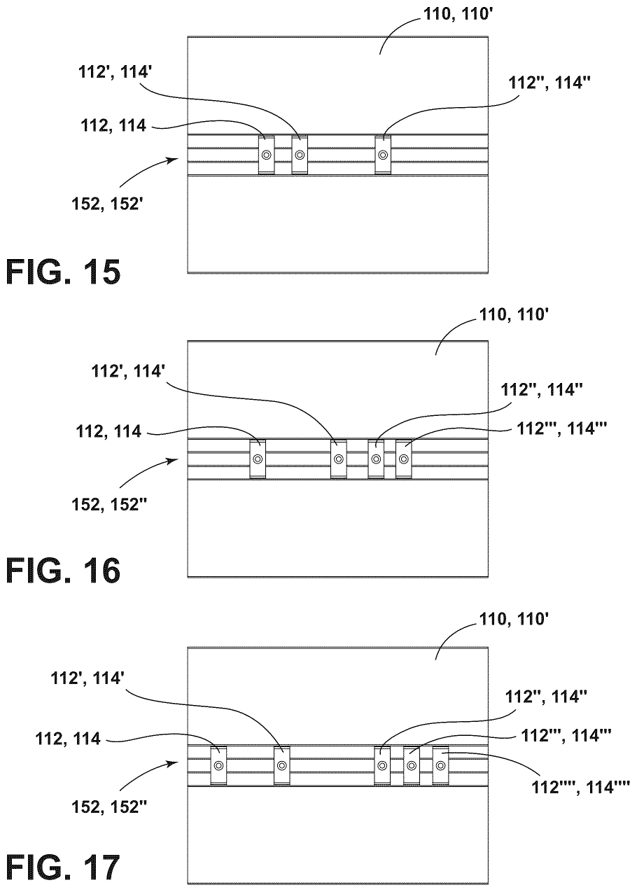

Referring now to FIGS. 15-17, the number of inserts 112, 114 connected to a cover 110 is chosen to correspond to the number of electrical conductors 122 of the cable 120 that are desired to be electrically connected via the electrical assembly 100. The positioning of each of the inserts 112, 114 within an inner channel 152 of a cover 110 is chosen to correspond with the arrangement (e.g., width, spacing, alignment, etc.) of the electrical conductors 122 in the cable 120 desired to be electrically connected.

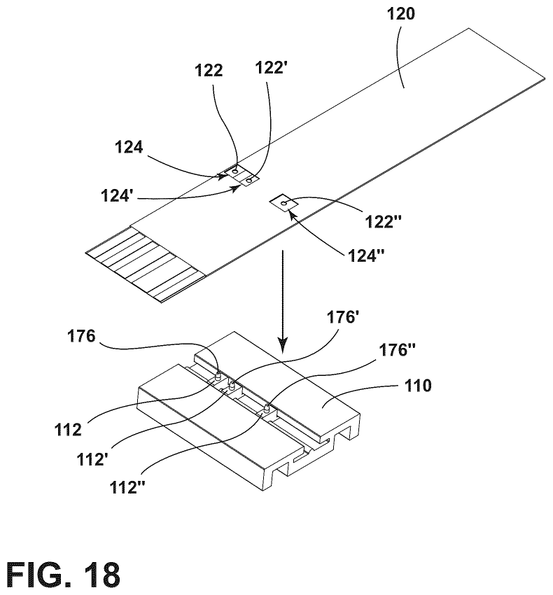

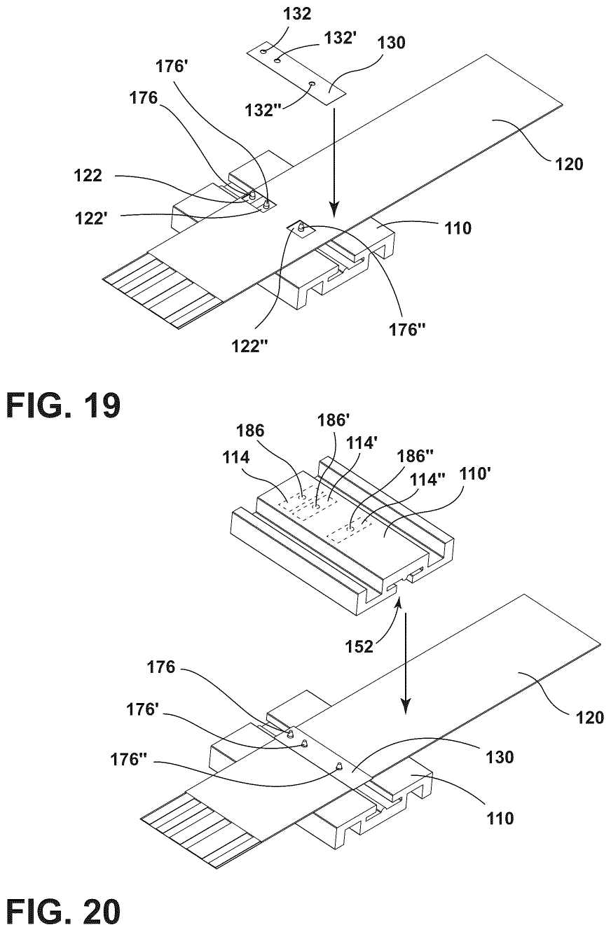

Referring now to FIGS. 18 and 19, the method includes forming at least two cable holes 124 into the flat cable 120 and/or forming at least two busbar holes 132 into the busbar 130. The number of cable holes 124 and/or the number of busbar holes 132 are chosen to correspond to the number of electrical conductors 122 of the cable 120 that are desired to be electrically connected via the electrical assembly 100. For example and without limitation, if three conductors 122, 122, 122′″ are intended to be connected, the method may include forming a first cable hole 124, a second cable hole 124′, and/or a third cable hole 124″ in the flat cable 120 and/or forming a first busbar hole 132, a second busbar hole 132′, and/or a third busbar hole 132″ into the busbar 130.

The method includes disposing the flat cable 120 in contact with the at least one of the covers 110, 110′ such that a protrusion 176 of a male insert 112 is partially disposed within a corresponding cable hole 124. For example and without limitation, in a configuration with three male inserts in the first cover 110, a first protrusion 176 of a first male insert 112 is partially disposed within a first cable hole 124, a second protrusion 176′ of a second male insert 112′ is partially disposed within a second cable hole 124′, and/or a third protrusion 176″ of a third male insert 112″ is partially disposed within a third cable hole 124″. The method includes disposing the busbar 130 in contact with the cable 120 such that a protrusion 176 of a male insert is partially disposed within a busbar hole 132 and/or a conductor 122 of the cable 120 is in contact with the busbar 130. For example and without limitation, the first protrusion 176 of the first male insert 112 is partially disposed within a first busbar hole 132, the second protrusion 176′ of the second male insert 112′ is partially disposed within a second busbar hole 132′, and/or the third protrusion 176″ of the third male insert 112″ is partially disposed within a third busbar hole 132″. A first conductor 122, a second conductor 122′, and/or a third conductor 122″ are in contact with the busbar 130.

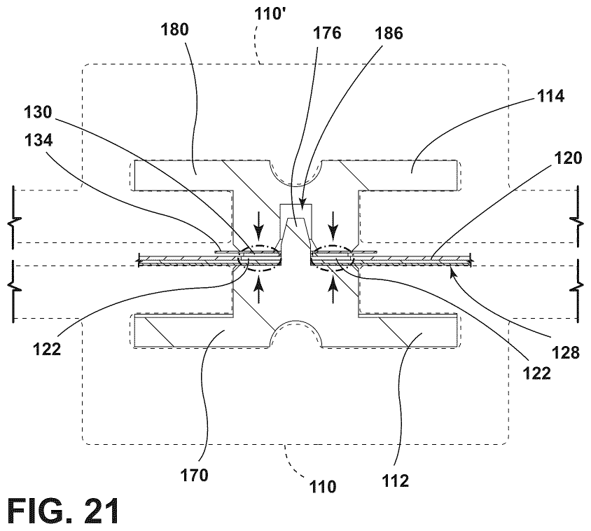

Referring now to FIGS. 20 and 21, the method includes connecting the second cover 110′ with the first cover 110. Connecting the covers 110, 110′ may include connecting inserts 112, 114 of the first cover 110 with inserts of the second cover 110, which may include inserting protrusions 176 of male inserts 112 into voids 186 of female inserts 114. For example and without limitation, in a configuration with three pairs of inserts 112, 114, the first protrusion 176 of a first male insert 112 is partially disposed within a first void 186 of a first female insert 114, the second protrusion 176′ of a second male insert 112′ is partially disposed within a second void 186′ of a second female insert 114′, and/or the third protrusion 176″ of a third male insert 112″ is partially disposed within a third void 186″ of a third female insert 114″. In the assembled configuration, a portion of a conductor 122 of the cable 120 and a portion of the busbar 130 are disposed between a base 170 of a male insert 112 and a base 180 of a female insert 114. For example, the base 170 of a male insert 112, the insulating material 128, the conductor 122, the busbar 130, the insulator 134,

In some configurations, the inserts 112, 114 inserted into the first cover 110 may contact a conductor 122 and/or the busbar 130 directly, at least to some degree, while the inserts 112, 114 inserted into the second cover 110′ may contact insulating material 128 of the cable 120 and/or an insulator 134 connected to the busbar 130. The inserts 112, 114 inserted into the second cover 110′ may not directly contact the conductor 122 and/or the busbar 130.

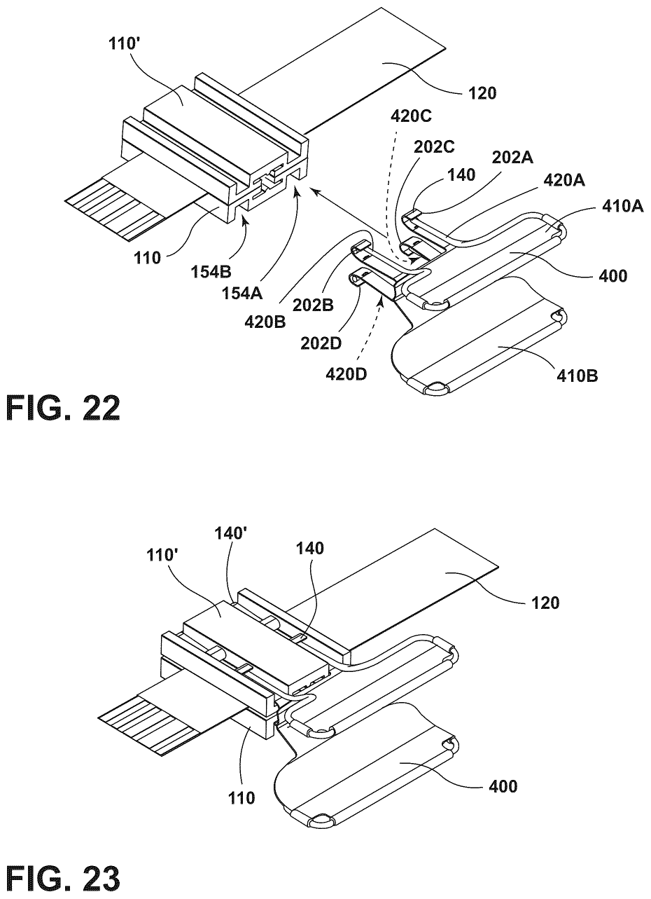

Referring now to FIGS. 22-24, a method of assembly may include securing the covers 110, 110′ together, which may include connecting a first spring clip 140 and/or a second spring clip 140′ to the first cover 110 and the second cover 110′, such as via a spring tool 400. The spring tool 400 includes a first portion 410A, a second portion 410B connected to the first portion 410A, and/or a plurality of extensions 420 (e.g., extensions 420A, 420B, 420C, 420D). In some configurations, a first extension 420A and a second extension 420B extend from the first portion 410A, and/or a third extension 420C and a fourth extension 420D extend from the second portion 410B. An extension 420 is configured for connection/contact with a respective leg 202 of a spring clip 140. For example and without limitation, the first extension 420A is configured for connection with a first leg 202A, the second extension 420B is configured for connection with a second leg 202B, the third extension 420C is configured for connection with a third leg 202C, and/or the fourth extension 420D is configured for connection with a fourth leg 202D.

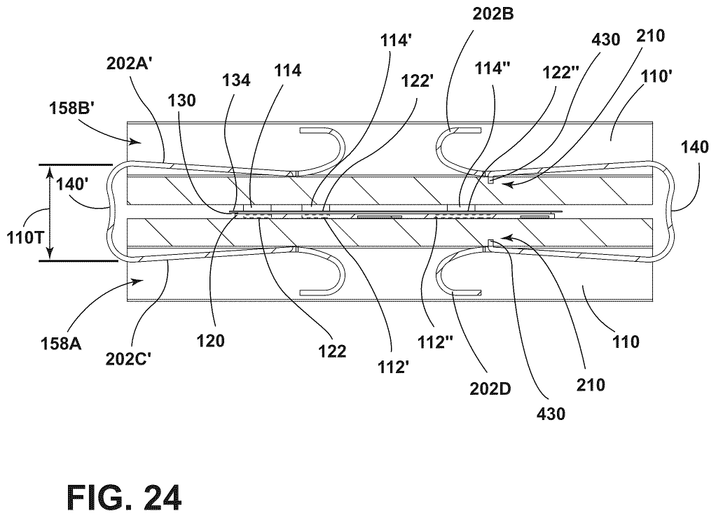

In accordance with the first portion 410A and the second portion 410B being manipulated (e.g., pressed together), the first extension 420A and the second extension 420B move away from the third extension 420C and the fourth extension 420D, such that the first leg 202A and the second leg 202B move away from the third 202C and the fourth leg 202D such that the gap between the legs 202A-B and the legs 202C-D is at least as large as a combined thickness 110T of the covers 110, 110′ at the outer channels 154A, 154A′. The spring tool 400 is then moved toward the covers 110, 110′ to insert the legs 202A-D into the outer channels 154A-B, 154A′-B′. In the assembled configuration, the first leg 202A of the first spring clip 140 is disposed in the second outer channel 154B′ of the second cover 110′, the second leg 202B is disposed in the first outer channel 154A′ of the second cover 110′, the third leg 202C is disposed in the first outer channel 154A of the first cover 110, and/or the fourth leg 202D is disposed in the second outer channel 154B of the first cover 110. The second spring clip 140′ may be connected to the covers 110, 110′ in a similar way from the opposite side of the covers 110, 110′. For example, in the assembled configuration, the first leg 202A′ of the second spring clip 140′ is disposed in the first outer channel 154A′ 22 of the second cover 110′, the second leg 202B″ is disposed in the second outer channel 154B′ of the second cover 110′, the third leg 202C′ is disposed in the second outer channel 154B of the first cover 110, and/or the fourth leg 202D′ is disposed in the first outer channel 154A of the first cover 110 (see, e.g., FIG. 2). Referring now to FIG. 24, in some implementations, one or more legs 202 of a spring clip 140 may include a projection 430. In the assembled configuration, a projection 430 may be disposed in a corresponding slot 210 of or otherwise engage (e.g., dig into) a cover 110 such as to restrict the spring clip 140 from disengaging from the cover 110.

The electrical assembly 100 may be used with cables 120 having a variety of conductor configurations. For example, inserts 112, 114 may be selected and inserted into covers 110 according to a first cable conductor configuration (e.g., two conductors 122), a second cable conductor configuration (e.g., three equally spaced conductors 122 having the same widths), and/or a third cable conductor configuration (e.g., three unequally spaced conductors 122 and/or conductors 122 having different widths), among a variety of other possible cable conductor configurations. The same covers 110 and/or spring clips 140 may be used for all of the conductor configurations. The design of the inserts 112, 114 may also be the same for all of the conductor configurations, with the number and positioning of the inserts 112, 114 varying for different configurations. A different insertion tool 300 may be used for each configuration or the insertion tool 300 may be adjustable.

While example embodiments are shown with the same type (male or female) of insert 112, 114 in a cover 110 and the other type in the second cover 110′, inserts 112, 114 of different types may be inserted into the same cover 110, 110′.

This disclosure includes, without limitation, the following embodiments:

1. An assembly, comprising: a first cover; a second cover connected with the first cover; a first male insert connected to the first cover; a first female insert connected to the second cover and the first male insert; a second male insert connected to one of the first cover and the second cover; a second female insert connected to the second male insert and the other one of the first cover and the second cover; and a busbar in contact with the first female insert and the second female insert.

2. The assembly according to embodiment 1, including a flat cable having a first conductor and a second conductor; wherein the second cover is connected with the first cover such that the first conductor is electrically connected with the second conductor via the busbar.

3. The assembly according to embodiment 1 or 2, wherein the busbar, the first male insert, the second male insert, the first female insert, and the second female insert electrically connect the first conductor with the second conductor.

4. The assembly according to any preceding embodiment, wherein: the first conductor includes a first hole, the second conductor includes a second hole, and the busbar includes a third hole and a fourth hole; the first male insert is partially disposed within the first hole and the third hole; and the second male insert is partially disposed within the second hole and the fourth hole.

5. The assembly according to any preceding embodiment, wherein a portion of the flat cable is disposed between the first cover and the second cover.

6. The assembly according to any preceding embodiment, including a spring clip; wherein the spring clip secures the second cover with the first cover.

7. The assembly according to any preceding embodiment, including a second spring clip; wherein the second spring clip is arranged on an opposite end of the assembly as the spring clip.

8. The assembly according to any preceding embodiment, wherein the second cover includes an identical configuration as the first cover.

9. The assembly according to any preceding embodiment, wherein: the first cover includes a first inner channel having a T-shaped configuration; the second cover includes a second inner channel having a T-shaped configuration; the first male insert is disposed in the first inner channel; and the first female insert is disposed in the second inner channel.

10. The assembly according to any preceding embodiment, wherein: the first cover includes a first rib disposed in the first inner channel; the second cover includes a second rib disposed in the second inner channel; the first rib extends an entire length of the first inner channel; and the second rib extends an entire length of the second inner channel.

11. The assembly according to any preceding embodiment, wherein: the first cover includes a first outer channel and a second outer channel; the second cover includes a third outer channel and a fourth outer channel; the assembly includes a spring clip; and portions of the spring clip are disposed in the first outer channel, the second outer channel, the third outer channel, and the fourth outer channel.

12. The assembly according to any preceding embodiment, wherein the first male insert, the second male insert, the first female insert, and the second female insert each include a T-shaped configuration and a recess having a shape that corresponds to a shape of the first rib and the second rib.

13. The assembly according to any preceding embodiment, wherein the first male insert, the second male insert, the first female insert, and the second female insert each include: a base; a first portion extending from the base in a first direction; and a second portion extending from the base in a second direction opposite the first direction; the base has a height greater than a height of the first portion and a height of the second portion.

14. The assembly according to any preceding embodiment, wherein the first male insert and the second male insert each include a protrusion extending from the base in a third direction orthogonal to the first direction and the second direction; and the first female insert and the second female insert each include a void corresponding to the protrusion.

15. The assembly according to any preceding embodiment, wherein the second cover is connected with the first cover such that (i) the protrusion of the first male insert is disposed in the void of the first female insert and (ii) a first conductor of a flat cable and a portion of the busbar are disposed between the bases of the first male insert and the first female insert.

16. A method of assembling the assembly according to embodiment 1, the method comprising: forming a first busbar hole in the busbar; forming a first cable hole in a conductor of a flat cable; inserting the first male insert into a first channel of the first cover; inserting the first female insert into a second channel of the second cover; disposing the flat cable in contact with the first cover such that the first male insert is partially disposed within the first cable hole; disposing the busbar in contact with the flat cable, such that the first male insert is partially disposed within the first busbar hole; and connecting the second cover with the first cover such that the first female insert is in contact with the busbar.

17. The method according to embodiment 16, including: forming a second busbar hole in the busbar; forming a second cable hole in a second conductor of the flat cable; inserting the second male insert into one of the first channel and the second channel; inserting the second female insert into the other one of the first channel and the second channel; and connecting the second cover with the first cover such that the second female insert is in contact with the busbar.

18. The method according to embodiments 16 or 17, wherein inserting the first male insert into the first channel includes: connecting the first male insert to an insertion tool; moving the insertion tool in a first direction such that a portion of the first male insert is disposed in the first channel and a portion of the insertion tool is in contact with the first cover; and moving the insertion tool in a second direction orthogonal to the first direction such that the first male insert is separated from the insertion tool.

19. The method according to embodiments 16-18, wherein inserting the first female insert into the second channel includes: connecting the first female insert to an insertion tool; moving the insertion tool in a first direction such that a portion of the first female insert is disposed in the second channel and a portion of the insertion tool is in contact with the second cover; and moving the insertion tool in a second direction orthogonal to the first direction such that the first female insert is separated from the insertion tool.

20. The method according to any of embodiments 16-19, including connecting a first spring clip to the first cover and the second cover, via a spring tool, such that a first leg and a second leg of the first spring clip are disposed in outer channels of the first cover and a third leg and a fourth leg of the first spring clip are disposed in outer channels of the second cover; and connecting a second spring clip to the first cover and the second cover, via the spring tool, such that a first leg and a second leg of the second spring clip are disposed in outer channels of the first cover and a third leg and a fourth leg of the second spring clip are disposed in outer channels of the second cover.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both element, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. An assembly, comprising:
a first cover;
a second cover connected with the first cover;
a first male insert connected to the first cover;
a first female insert connected to the second cover and the first male insert;
a second male insert connected to one of the first cover and the second cover;
a second female insert connected to the second male insert and the other one of the first cover and the second cover; and
a busbar in contact with the first female insert and the second female insert.

2. The assembly of claim 1, including a flat cable having a first conductor and a second conductor;
wherein the second cover is connected with the first cover such that the first conductor is electrically connected with the second conductor via the busbar.

3. The assembly of claim 2, wherein the busbar, the first male insert, the second male insert, the first female insert, and the second female insert electrically connect the first conductor with the second conductor.

4. The assembly of claim 2, wherein:
the first conductor includes a first hole, the second conductor includes a second hole, and the busbar includes a third hole and a fourth hole;
the first male insert is partially disposed within the first hole and the third hole; and
the second male insert is partially disposed within the second hole and the fourth hole.

5. The assembly of claim 2, wherein a portion of the flat cable is disposed between the first cover and the second cover.

6. The assembly of claim 1, including a spring clip;
wherein the spring clip secures the second cover with the first cover.

7. The assembly of claim 6, including a second spring clip;
wherein the second spring clip is arranged on an opposite end of the assembly as the spring clip.

8. The assembly of claim 1, wherein the second cover includes an identical configuration as the first cover.

9. The assembly of claim 1, wherein:
the first cover includes a first inner channel having a T-shaped configuration;
the second cover includes a second inner channel having a T-shaped configuration;
the first male insert is disposed in the first inner channel; and
the first female insert is disposed in the second inner channel.

10. The assembly of claim 9, wherein:
the first cover includes a first rib disposed in the first inner channel;
the second cover includes a second rib disposed in the second inner channel;
the first rib extends an entire length of the first inner channel; and
the second rib extends an entire length of the second inner channel.

11. The assembly of claim 1, wherein:
the first cover includes a first outer channel and a second outer channel;
the second cover includes a third outer channel and a fourth outer channel;
the assembly includes a spring clip; and
portions of the spring clip are disposed in the first outer channel, the second outer channel, the third outer channel, and the fourth outer channel.

12. The assembly of claim 10, wherein the first male insert, the second male insert, the first female insert, and the second female insert each include a T-shaped configuration and a recess having a shape that corresponds to a shape of the first rib and the second rib.

13. The assembly of claim 1, wherein the first male insert, the second male insert, the first female insert, and the second female insert each include:
a base;
a first portion extending from the base in a first direction; and
a second portion extending from the base in a second direction opposite the first direction;
the base has a height greater than a height of the first portion and a height of the second portion.

14. The assembly of claim 13, wherein the first male insert and the second male insert each include a protrusion extending from the base in a third direction orthogonal to the first direction and the second direction; and
the first female insert and the second female insert each include a void corresponding to the protrusion.

15. The assembly of claim 14, wherein the second cover is connected with the first cover such that (i) the protrusion of the first male insert is disposed in the void of the first female insert and (ii) a first conductor of a flat cable and a portion of the busbar are disposed between the bases of the first male insert and the first female insert.

16. A method of assembling the assembly of claim 1, comprising:
forming a first busbar hole in the busbar;
forming a first cable hole in a conductor of a flat cable;
inserting the first male insert into a first channel of the first cover;
inserting the first female insert into a second channel of the second cover;
disposing the flat cable in contact with the first cover such that the first male insert is partially disposed within the first cable hole;
disposing the busbar in contact with the flat cable, such that the first male insert is partially disposed within the first busbar hole; and
connecting the second cover with the first cover such that the first female insert is in contact with the busbar.

17. The method of claim 16, including:
forming a second busbar hole in the busbar;
forming a second cable hole in a second conductor of the flat cable;
inserting the second male insert into one of the first channel and the second channel;
inserting the second female insert into the other one of the first channel and the second channel; and
connecting the second cover with the first cover such that the second female insert is in contact with the busbar.

18. The method of claim 16, wherein inserting the first male insert into the first channel includes:
connecting the first male insert to an insertion tool;
moving the insertion tool in a first direction such that a portion of the first male insert is disposed in the first channel and a portion of the insertion tool is in contact with the first cover; and
moving the insertion tool in a second direction perpendicular to the first direction such that the first male insert is separated from the insertion tool.

19. The method of claim 16, wherein inserting the first female insert into the second channel includes:
connecting the first female insert to an insertion tool;
moving the insertion tool in a first direction such that a portion of the first female insert is disposed in the second channel and a portion of the insertion tool is in contact with the second cover; and
moving the insertion tool in a second direction orthogonal to the first direction such that the first female insert is separated from the insertion tool.

20. The method of claim 16, including connecting a first spring clip to the first cover and the second cover, via a spring tool, such that a first leg and a second leg of the first spring clip are disposed in outer channels of the first cover and a third leg and a fourth leg of the first spring clip are disposed in outer channels of the second cover; and
connecting a second spring clip to the first cover and the second cover, via the spring tool, such that a first leg and a second leg of the second spring clip are disposed in outer channels of the first cover and a third leg and a fourth leg of the second spring clip are disposed in outer channels of the second cover.
